(19) United States
(12) Patent Application Publication
(10) Pub. No.: US 2018/0336628 A1
(43) Pub. Date: Nov. 22, 2018

(54) Methods for Transferring Credit, Credit Transfer Servers, and Computer Readable Media

(71) Applicant: MASTERCARD INTERNATIONAL INCORPORATED, PURCHASE, NY (US)

(72) Inventors: Rahul Agrawal, Pune (IN); Sudhir Gupta, Pune (IN)

(21) Appl. No.: 15/972,544

(22) Filed: May 7, 2018

(30) Foreign Application Priority Data
May 22, 2017 (SG) 10201704144W

(51) Int. Cl. G06Q 40/02; G06Q 20/34

(52) U.S. Cl. CPC G06Q 40/02; G06Q 20/341

(57) ABSTRACT

According to various embodiments, there is provided a method for transferring credit from a first card belonging to a first user to a second card belonging to a second user, the method comprising: receiving from the first user an offer message indicating an offer including an offered amount, wherein the offer further includes other information, the other information including one or more of cost, time, or other terms and conditions; receiving from the second user a request message indicating a request for a requested amount; determining whether the offer and the request fulfil a pre-determined condition; and if it is determined that the offer and the request fulfil the pre-determined condition, initiating debiting a pre-determined amount from the first card and crediting the pre-determined amount to the second card.

### CROSS-REFERENCE TO RELATED APPLICATION

This application claims the benefit of and priority to Singapore Patent Application No. 10201704144 W filed May 22, 2017. The entire disclosure of the above application is incorporated herein by reference.

### FIELD

The present disclosure relates broadly, but not exclusively, to methods for transferring credit, credit transfer servers, and computer readable media.

### BACKGROUND

This section provides background information related to the present disclosure which is not necessarily prior art.

Most of people don't use their complete credit limit. Despite having a good credit limit, for example people utilize only 15-20% out of it. Thus, even with having good credit limit, people usually don't have any added value from the good credit limit.

On the other hand, sometimes buyers are not able to make a purchase due to a slight shortage in credit limit. For example, if someone is short of just $100 while making a credit card payment, he or she cannot purchase the item.

Meanwhile, people cannot share their credit limits due to the following reasons: people don't want to give credit without interest; people fear losing money; and/or people don't want to share their card details.

A need therefore exists to provide methods and/or systems to address the above problem.

### SUMMARY

This section provides a general summary of the disclosure, and is not a comprehensive disclosure of its full scope or all of its features. Aspects and embodiments of the disclosure are set out in the accompanying claims.

According to a first aspect, there is provided a method for transferring credit from a first card belonging to a first user to a second card belonging to a second user, the method comprising: receiving from the first user an offer message indicating an offer including an offered amount, wherein the offer further includes other information, the other information including one or more of cost, time, or other terms and conditions; receiving from the second user a request message indicating a request for a requested amount; determining whether the offer and the request fulfil a pre-determined condition; and if it is determined that the offer and the request fulfil the pre-determined condition, initiating debiting a pre-determined amount from the first card and crediting the pre-determined amount to the second card.

According to a second aspect, there is provided a credit transfer server for transferring credit from a first card belonging to a first user to a second card belonging to a second user. The credit transfer server comprising: a receiver configured to receive from the first user an offer message indicating an offer including an offered amount, wherein the offer further includes other information, the other information including one or more of cost, time, or other terms and conditions, the receiver further configured to receive from the second user a request message indicating a request for a requested amount; a determination circuit configured to determine whether the offer and the request fulfil a pre-determined condition; and a transfer initiator configured to initiate debiting a pre-determined amount from the first card and crediting the pre-determined amount to the second card if it is determined that the offer and the request fulfil the pre-determined condition.

According to a third aspect, there is provided a computer readable medium comprising instructions which, when executed by a processor, make the processor perform a method for transferring credit from a first card belonging to a first user to a second card belonging to a second user, the method comprising: receiving from the first user an offer message indicating an offer including an offered amount, wherein the offer further includes other information, the other information including one or more of cost, time, or other terms and conditions; receiving from the second user a request message indicating a request for a requested amount; determining whether the offer and the request fulfil a pre-determined condition; and if it is determined that the offer and the request fulfil the pre-determined condition, initiating debiting a pre-determined amount from the first card and crediting the pre-determined amount to the second card.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. Embodiments and implementations are provided by way of example only, and will be better understood and readily apparent to one of ordinary skill in the art from the following written description, read in conjunction with the drawings, in which:

FIG. 1A shows a flow diagram illustrating a method for transferring credit from a first card belonging to a first user to a second card belonging to a second user according to various embodiments;

FIG. 1B shows a credit transfer server according to various embodiments;

FIG. 2 shows an illustration of information flow according to various embodiments;

FIG. 3 shows an illustration of a transaction flow between an electronic wallet of a first user and a server for offering a loan according to various embodiments;

FIG. 4 shows an illustration of a transaction flow between a wallet of a second user and a server for availing a loan according to various embodiments;

FIG. 5 shows an illustration of a transaction flow between the server, the issuer of the card of the first user and the issuer of the card of the second user according to various embodiments; and

FIG. 6 depicts an exemplary computing device according to various embodiments.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

Various embodiments provide devices and methods for subletting of a credit limit (which may be referred to as SCL).

A credit limit is provided in association with a credit card. Often, holders of a credit card don't use the credit card limit, and thus miss the chance to utilize the grace period provided to them. Since in that grace period, the issuer won't charge for the expenditure done on the credit card, the holders could make multiple transactions in that time period. It will be understood that multiple transactions means a user having the facility of using its credit money in different ways. For example, the user can opt for the option of providing a loan amount for some part of money and make transactions for the rest of the money. For example, if the user has $5000 as credit available to him, the user can provide $2500 as a loan amount and the rest of the amount can be utilized for his own personal expenses. Again, the user always has the option open for providing more loan amounts. So later, the user can also offer more loan amounts of the rest of the money available to him (i.e., $2500), so the user can make multiple transactions. For example, the user has a $5000 credit limit and the user wants to offer $2500 as a loan and the remaining $2500 for personal use. But later if the user used only $1000 from $2500, again he can offer $1500 for a loan with different dates.

According to various embodiments, devices and methods are provided with which a holder of a credit card can earn money from the grace period on his credit card. The credit card issuer (who, for example, may be a franchisee of Mastercard®) may put a lock (or get a hold) on a respective amount of money available in the credit card of the holder with the acceptance from the holder. Once the money is locked by the credit card issuer, the credit card issuer looks for another card holder (who may be referred to as requester), who is seeking for a short term (online) loan. The credit card issuer offers them required money (for example, on the basis of their CIBIL score and payment tracks) with the required terms and conditions. Advantageously, once the terms and conditions are accepted by the requester, the money is transferred to his account and ECS (electronic clearance service) requests are raised against his card, for example, his debit card (or his debit account).

Hence, the user earns some interest from his un-utilized money. The credit card issuer earns interest and fees. The requester can avail the loan for a given time in urgency without any paper work needed.

In an example, a first user offers an amount on which the first user wants to earn interest. The first user sends a request to the server accordingly. Once the first user offers that amount, the server verifies the credit limit with the first issuer and gets the hold on that limit.

When, for example, a second user is in need of money, the second user sends a request to the server for requesting a loan. The server checks the availability of the amount and verifies the second user and its credit history. If the credit loan request satisfies all necessary conditions, the server sends “Terms and Conditions” to the second user, together with an interest rate and an approved amount.

If the second user accepts the Terms and Conditions and notifies the server about his acceptance, the server sends a respective ECS (registration) request to the second issuer on the second user's behalf.

Once the ECS request is approved, the server deducts the approved amount from the credit card of the first user, and deposits the amount into the requestor's account.

When the loan period is over, an ECS request is triggered and the amount is deducted from the second user's account along with costs (for example, interest).

The server pays the credit bill of the first user's account, and after deducting the profit, the interest earned by the first user is sent to the first user.

Advantageously, various embodiments can provide a big boost in terms of providing loans on short term and with less hassle. There shall be no paper work required. In addition, options like good CIBIL score with authenticated cards or accounts can be used to shortlist the list of users for such services.

Advantageously, with the devices and methods according to various embodiments, people don't need to go to the bank and follow the paper work even if the loan amount is small. This is a great usage for those who prefer cashless and online payment.

### Terms Description (in Addition to Plain and Dictionary Meaning of Terms)

A card (for example, the first card or the second card) is a card associated with an account, and may either be a credit card or a debit card. For example, the first card is a credit card, and, for example, the second card is a debit card; in other words, to avail a loan facility, the user receiving credit, for example, has a debit card or debit amount, so that an amount can be transferred to that account after deducting it from the credit card of the user giving credit (and this transaction is, for example, carried out by the server). It will be understood that card and account are used interchangeable—each card is connected with an account, and an account has at least one card connected with it.

A credit is money that is available to a person (or user), either from funds deposited into an account or in terms of a credit line (in other words: credit limit) on a credit card. For example, if a user has a credit line of $5,000, but has only used $2,000 so far, he still can spend another $3,000. According to various embodiments, the user can offer the $3,000 as a loan to other users.

An offered amount is an amount that a user (for example, the first user) is offering. For example, the offered amount is an amount of the first user's credit line (in other words: credit limit) associated with the first card, for example, a credit card. A requested amount is an amount that the second user is requesting to credit on the second card, for example, a debit card.

Crediting an amount means providing the amount for spending or to pay off debts. Debiting an amount means taking the amount from an account.

A credit score (or example CIBIL score) of a user is an evaluation of the creditworthiness of the user. The credit score, for example, is a number, wherein, for example, a lower number indicates a lower creditworthiness. For example, a credit score of 0 indicates that the user is not creditworthy at all. For example, a credit score of 100 is the best credit score available. Other than expressing the credit score by a number, the credit score can also be expressed in terms of plain text description (for example ‘not creditworthy’, ‘medium creditworthy’, ‘above average creditworthy’).

Getting a hold on an amount (in other words: putting a lock on an amount) on a credit card means blocking the amount for a pre-determined later use. For example, according to various embodiments, the amount the first user offers as a loan is blocked, so that the first user cannot spend this amount while his offer for a loan is processed and a corresponding loan-taker (for example, the second user) is found.

Costs of a loan, for example, include the interest and/or a processing fee.

Various credit cards and debit cards of a user may be managed in a user's e-wallet (electronic wallet), which may be referred to as “wallet” for short. An example of an e-wallet is Masterpass®, which is a digital payment service from Mastercard® that provides fast, simple and secure digital payments across devices and channels. Masterpass®, for example, provides an interface for selecting which card of a plurality of cards that a user holds to use for a certain transaction.

### Exemplary Embodiments

Embodiments will be described, by way of example only, with reference to the drawings. Like reference numerals and characters in the drawings refer to like elements or equivalents.

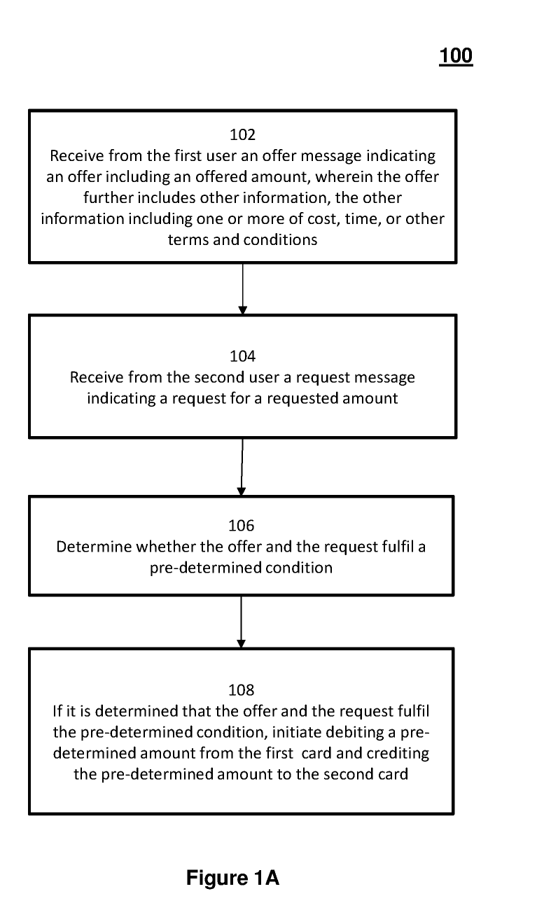

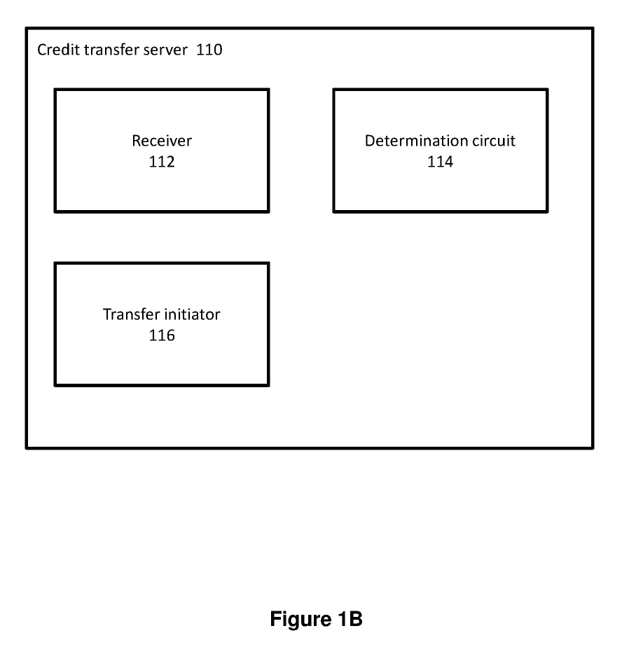

FIG. 1A shows a flow diagram 100 illustrating a method for transferring credit from a first card, for example, a credit card, belonging to a first user to a second card, for example, a debit card, for example, in relation to a debit account, belonging to a second user according to various embodiments. In 102, an offer message indicating an offer including an offered amount is received from the first user. The offer further includes other information, the other information including one or more of cost, time, or other terms and conditions. In 104, a request message indicating a request for a requested amount is received from the second user. In 106, it is determined whether the offer and the request fulfil a pre-determined condition. In 108, if it is determined that the offer and the request fulfil the pre-determined condition, debiting a pre-determined amount from the first card, for example a credit card, and crediting the pre-determined amount to the second card, for example a debit card, or to a debit account is initiated.

In other words, a first user can offer an amount available in his card for loan, and a second user who is requesting a loan can (at least partially) receive the loan from the amount offered by the first user.

According to various embodiments, the pre-determined condition includes that the request is originating from a user whose credit score fulfils a pre-determined requirement.

According to various embodiments, the method further includes determining a credit score of the second user.

According to various embodiments, the pre-determined condition includes that the requested amount is less or equal to the offered amount.

According to various embodiments, the pre-determined condition includes that a requested time is less or equal to an offered time.

According to various embodiments, the pre-determined condition includes that the second user is agreeing to the other information.

According to various embodiments, the pre-determined amount is less or equal to the offered amount.

According to various embodiments, the pre-determined amount is less or equal to the requested amount.

According to various embodiments, the method further includes getting a hold on the offered amount in the first card.

According to various embodiments, the method further includes: receiving offers from a plurality of users; and matching the request to one or more of the plurality of users.

According to various embodiments, the requested amount is less or equal to the sum of offered amounts of users to which the request is matched.

According to various embodiments, the matching is based on respective costs of the offers.

According to various embodiments, the method further includes initiating debiting a first return amount based on the pre-determined amount from the second card and crediting a second return amount based on the pre-determined amount to the first card.

According to various embodiments, the first return amount is based on the pre-determined amount and an interest to be paid by the second user.

According to various embodiments, the second return amount is based on the pre-determined amount and an interest earned by the first user.

According to various embodiments, the first return amount is based on the pre-determined amount and a profit of an issuer of at least one of the first card or the second card; and the second return amount is based on the pre-determined amount and the profit.

According to various embodiments, the offered amount is an amount of the first user's credit line associated with the first card.

According to various embodiments, the offered amount is an amount that is available to the first user from the first card free of interest.

FIG. 1B shows a credit transfer server 110 for transferring credit from a first card belonging to a first user to a second card belonging to a second user according to various embodiments. The credit transfer server 110 includes a receiver 112 (in other words: a receiver circuit) configured to receive from the first user an offer message indicating an offer including an offered amount. The offer further includes other information, the other information including one or more of cost, time, or other terms and conditions. The receiver 112 is further configured to receive from the second user a request message indicating a request for a requested amount. The credit transfer server 110 further includes a determination circuit 114 configured to determine whether the offer and the request fulfil a pre-determined condition. The credit transfer server 110 further includes a transfer initiator 116 (in other words: a transfer initiator circuit) configured to initiate debiting a pre-determined amount from the first card, for example a credit card, and crediting the pre-determined amount to the second card (for example a debit card or a debit account) if it is determined that the offer and the request fulfil the pre-determined condition.

According to various embodiments, the pre-determined condition includes that the request is originating from a user whose credit score fulfils a pre-determined requirement.

According to various embodiments, the determination circuit 114 is further configured to determine a credit score of the second user.

According to various embodiments, the pre-determined condition includes that the requested amount is less or equal to the offered amount.

According to various embodiments, the pre-determined condition includes that a requested time is less or equal to an offered time.

According to various embodiments, the pre-determined condition includes that the second user is agreeing to the other information.

According to various embodiments, the pre-determined amount is less or equal to the offered amount.

According to various embodiments, the pre-determined amount is less or equal to the requested amount.

According to various embodiments, the credit transfer server 110 further includes a get-hold circuit (not shown in FIG. 1B) configured to get a hold on the offered amount in the first card.

According to various embodiments, the receiver 112 is further configured to receive offers from a plurality of users. According to various embodiments, the transfer initiator 116 is further configured to match the request to one or more of the plurality of users.

According to various embodiments, the requested amount is less or equal to the sum of offered amounts of users to which the request is matched.

According to various embodiments, the matching is based on respective costs of the offers.

According to various embodiments, the transfer initiator 116 is configured to initiate debiting a first return amount based on the pre-determined amount from the second card and crediting a second return amount based on the pre-determined amount to the first card.

According to various embodiments, the first return amount is based on the pre-determined amount and an interest to be paid by the second user.

According to various embodiments, the second return amount is based on the pre-determined amount and an interest earned by the first user.

According to various embodiments, the first return amount is based on the pre-determined amount and a profit of an issuer of at least one of the first card or the second card; and the second return amount is based on the pre-determined amount and the profit.

According to various embodiments, the offered amount is an amount of the first user's credit line associated with the first card.

According to various embodiments, the offered amount is an amount that is available to the first user from the first card free of interest.

According to various embodiments, a (for example, non-transitory) computer readable medium is provided, which includes instructions which, when executed by a processor, make the processor perform a method for transferring credit from a first card belonging to a first user to a second card belonging to a second user (for example, the method illustrated in the flow diagram 100 of FIG. 1).

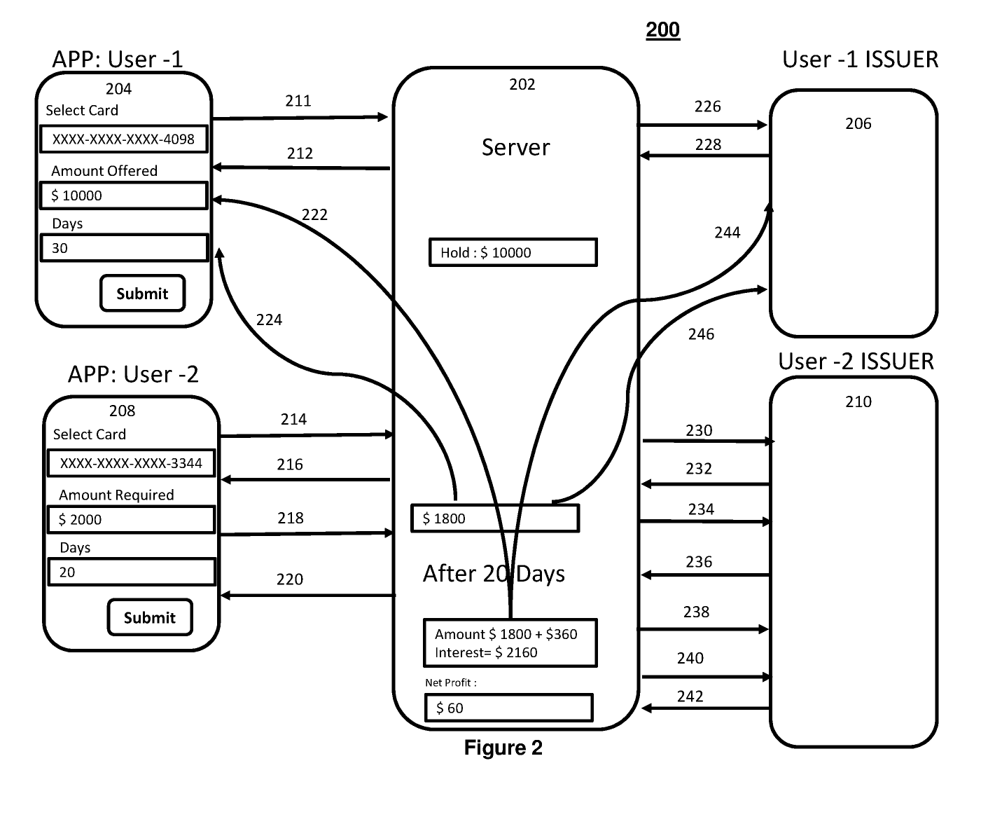

FIG. 2 shows an illustration 200 of information flow according to various embodiments between a server 202 (for example, a credit transfer server, for example, a server managed by Mastercard®), an application 204 (for example, an e-wallet, for example, a Masterpass®) of a first user, an issuer 206 of a credit card of the first user, an application 208 (for example, an e-wallet, for example, a Masterpass®) of a second user, and an issuer 210 of a credit card of the first user. It will be understood that the server 202 can be facilitated by various entities and, for example, of one such entities is Mastercard®.

According to various embodiments, as illustrated in FIG. 2, devices and methods are provided to sublet a credit limit in the market in order to gain interest.

A first user (in other words, user 1) offers an amount on which the first user wants to earn the interest. The first user sends a request 211 to the server 202 accordingly. Once the first user offered that amount (in other words: once the server 202 receives the request 211), the server 202 verifies the credit limit with the first issuer 206 (in other words: with issuer 1; in other words: with the issuer of the card of the first user) and gets the hold on that limit, for example, when using an automated fuel dispenser machine or when making a hotel booking (or any other similar instance where money is blocked on a credit card, which means that the money is still not deducted from the credit card, but reserved, so that it is ensured that at a later stage, if necessary, the money indeed can be deducted from the account). In other words, in order to get the hold on the offered amount, the server 202 sends a request 226 (based on the request 211 received from the first user) to the first issuer 206, to check the credit limits of the first user and to get the hold. The first issuer 206 replies with a message 228, indicating that the first issuer 206 got the hold on the amount. The server 202 notifies the first user accordingly with message 212.

When, for example, the second user (in other words, user 2) is in need of money, the second user sends a request 214 to the server 202 for requesting a loan. The server 202 checks the availability of the amount and verifies the requestor (i.e., the second user) and its credit history. For example, the server 202 verifies that second user from the second issuer 210 (in other words: with issuer 2; in other words: with the issuer of the card of the second user) and checks the credit score, and if all ok, sends terms and conditions to the second user. In more detail, the server 202 sends a message 230 to the second issuer 210 to verify the details of the second user and to request a credit history of the second user from the second issuer 210. The second issuer 210 responds with a message 232, for example, indicating that the second user is verified and with the credit score of the second user (which, for example, is a number, for example, 85). If the credit loan request satisfies all the conditions, the server 202 sends the “Terms and Conditions” to the requestor (the second user) in a message 216, together with an interest rate (for example, 1% per day) and an approved amount (for example, $1800).

If the requestor accepts the Terms and Conditions (including the interest rate) and notifies the server 202 about his acceptance in a message 218, the server 202 sends a respective ECS (registration) request 234 to the second issuer 210 on the requestor's behalf.

Once the ECS request is approved, and this is indicated by message 236, the server 202 deducts the approved amount from the (credit) card of the first user (like indicated by arrow 246, which for example represents a deduction of $1800 from card number XXXX-XXXX-XXXX-4098, i.e. from the card of the first user), and deposits the amount into the requestor's account (like indicated by arrow 238), and notifies all the stakeholders (with a message 224 to the first user and a message 220 to the second user).

When the loan period (for example 20 days) is over, an ECS request 240 is triggered and the amount is deducted from (in other words: debited from) the requestor account along with costs (for example interest; for example $1800 of the original amount plus an interest of $360)), as indicated by arrow 242.

The server 202 pays the credit bill of the first user's account (as indicated by arrow 244, where for example, a deposit of $1800 is deposited to XXXX-XXXX-XXXX-4098), and after deducting the profit, the interest earned by the first user is sent to the first user, as indicated by arrow 222.

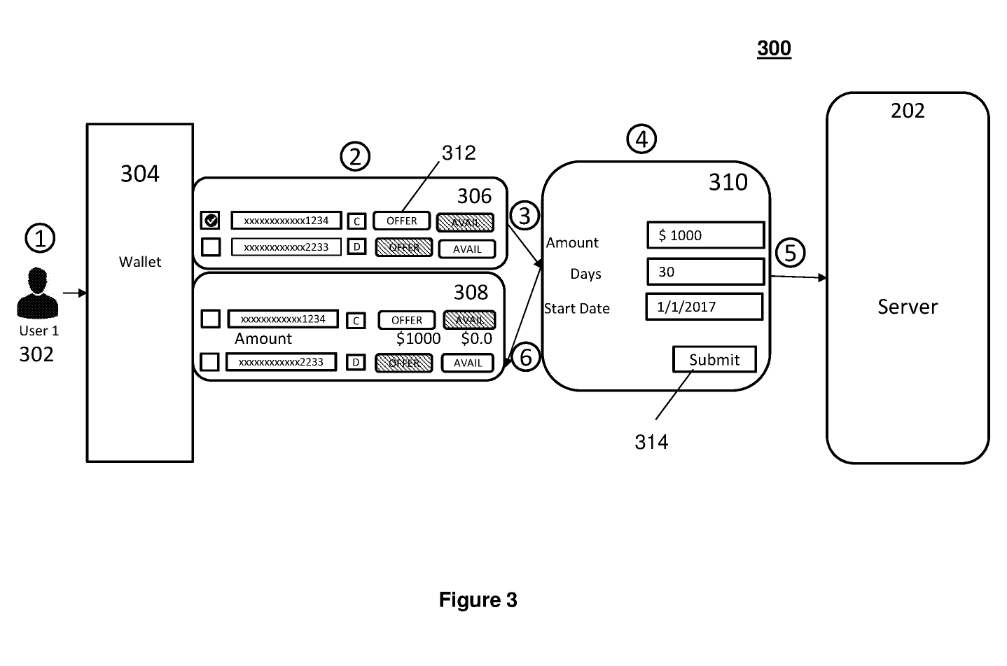

FIG. 3 shows an illustration 300 of a transaction flow between a first user 302 (in other words: User 1) and (the first user's) Masterpass® 304 for offering a loan according to various embodiments. Various steps illustrated in FIG. 3 are indicated by encircled numbers (for example, a first step is indicated by an encircled number 1). In a first step, the user 302 selects his e-wallet (for example, Masterpass®) as the payment gateway option during transaction. In a second step and a third step, at the Masterpass® page 306, the user sees an option of providing a loan and availing a loan against its available cards. In case the listed card is a debit card, then the user 302 can only avail loans and won't be able to offer loans. In the illustration 300, a card ending on 1234 is selected as a credit card (as illustrated in view 306), where the user wishes to offer $1000 as a loan. Once user clicks on an “Offer” button 312, a new page 310 is displayed, where details are required to process it further. It will be understood that step 3 is the step of offering a loan. In views 306, 308 of the Masterpass®, a “C” in a box stands for credit card or credit account, and “D” in a box stands for debit card or debit account. For example, the user can only offer a loan on credit card. In other words, as an example, the user can offer a loan amount to others from his credit card and not his debit card. As shown in FIG. 3, if both types of accounts (credit card and debit card) are available to a user the credit card has the loan option enabled to the user (as shown by unshaded boxes representing switches for offer in views 306, 308 in the respective first line associated with a credit card, as indicated by boxed letter “C”), and the debit card has the loan option disabled (as shown by shaded boxes representing switches for offer in views 306, 308 in the respective second line associated with a debit card, as indicated by boxed letter “D”). Likewise, availing credit may only be provided for debit cards (or debit accounts).

In a fourth step, the user needs to provide details, for example, the following details: amount (an amount which is provided by the user as a loan), number of days (the loan should be provided for the given number of days), and start date (the date from which user wants to start the loan process).

Once user offers that amount, Masterpass® verifies the credit limit with the issuer of the card of the first user 302 and gets the hold on that limit, for example, an automated fuel dispenser machine or during hotels bookings.

In a fifth step, once the user clicks on a submit button 314, a notification is sent to the server 202. Once the user offers that amount, Masterpass® verifies the credit limit with User-1 Issuer and gets the hold on that limit, for example, when using an automated fuel dispenser machine or making a hotel booking.

In a sixth step, the offered amount is updated in Masterpass®, as illustrated by view 308.

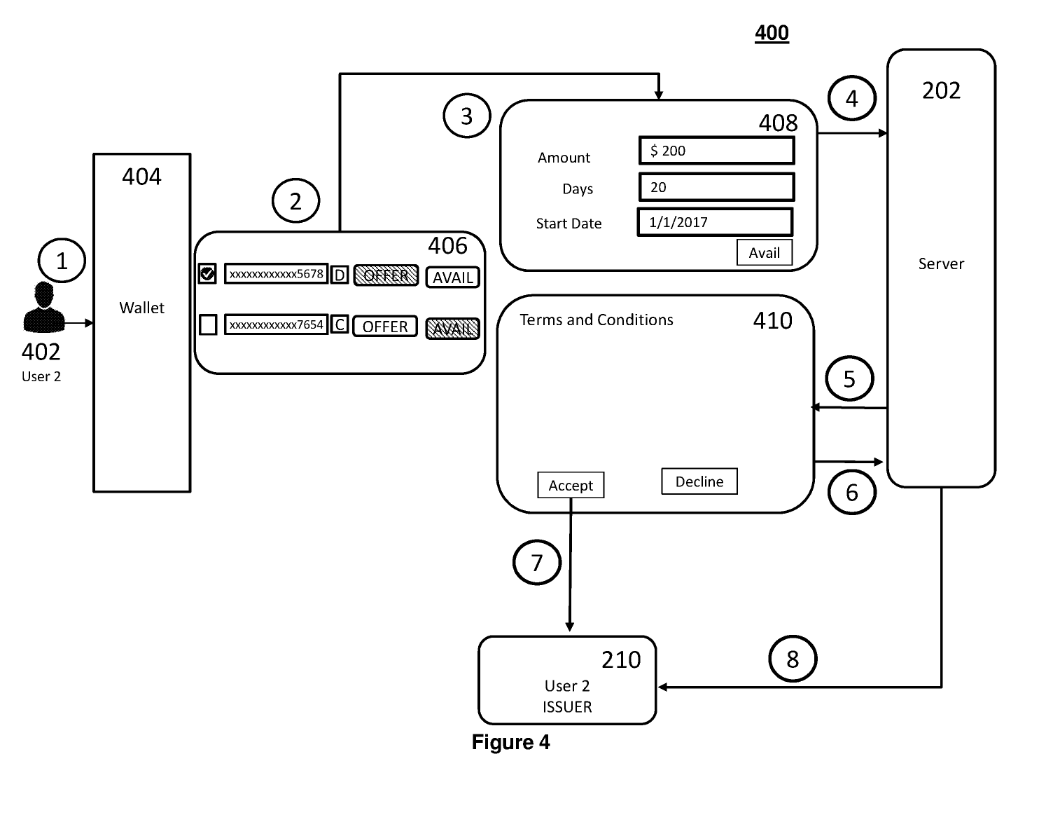

FIG. 4 shows an illustration of a computing device 400 of a transaction flow between a second user 402 (in other words: User 2) and (the second user's) Masterpass® 404 for availing a loan according to various embodiments. Various steps illustrated in FIG. 4 are indicated by encircled numbers (for example, a first step is indicated by an encircled number 1). In a first step, the second user 402 selects Masterpass® as the payment gateway option during transaction. In a second step and third step, at the Masterpass® page, the second user 402 sees an option of availing a loan in view 406. The avail loan option may only be visible to the second user, when the second user has good credit score/history. As an example, the card ending on 5678 is a credit card where user wishes to avail $200 as a loan. Once the user clicks on an “Avail” button 412, a new page 408 is displayed where further details are required to proceed.

In a fourth step, the second user 402 provides details, for example, the following details: amount (an amount which user wants to avail as a loan), number of days (the loan should be availed for the given number of days), and start date (the date from which the second user 402 wants to start the loan process). An according request is then sent to the server 202.

In a fifth step, the server 202 checks the availability of the requested amount. If the amount is available, the server sends terms and conditions to the second user, which are displayed in view 410. The view 410 further includes the following information (not illustrated in FIG. 4):

Interest rate: 1%/day;

Approved Amount: $180;

Total Days: 20;

Interest Calculated: $36;

Total Amount: $180+$36=$216;

Amount will be deducted from listed CARD5678;

Deduction Day: 21 Jan. 2017.

If the second user 402 accepts the terms and conditions in a sixth step, an ECS request is sent to the issuer 210 of the card of the second user in a seventh step.

Issuer and acceptance notifications are then sent to the server 202.

In an eighth step, if the second user 402 accepts the terms and conditions, the server 202 debits the amount from the issuer of the first user's card and deposits it into the account of the second user 402 (for example, on his card; for example, $180 is credited into the card ending with 5678).

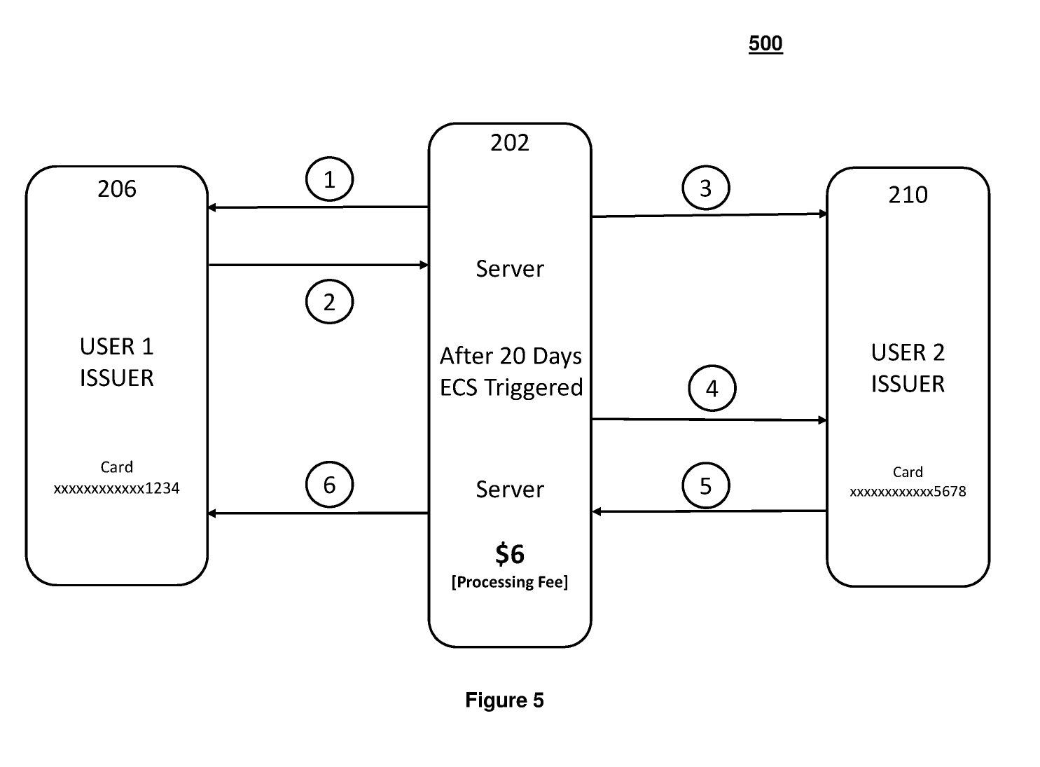

FIG. 5 shows an illustration of a computing device 500 of a transaction flow between the server 202, the issuer 206 of the card of the first user and the issuer 210 of the card of the second user according to various embodiments. Various steps illustrated in FIG. 5 are indicated by encircled numbers (for example, a first step is indicated by an encircled number 1). In a first step, when the second user accepts the terms and condition (similar to the eighth step of FIG. 4), the server 202 sends a debit request to the issuer 206 of the card of the first user (for example, a debit request is raised for $180 from card xxxxxxxxxxxx1234, i.e., the card ending with 1234).

In a second step and a third step, when the issuer 206 of the card of the first user approves the amount (in the second step, for example, with an ‘approved’ message), the server 202 deducts that amount from the issuer 206 of the card of the first user and (in the third step) deposits it into the account with the issuer 210 of the card of the second user (for example, in the third step, an amount of $180 is credited to the issuer 210 against the card of the second user, for example, card xxxxxxxxxxxx5678, i.e., the card ending with 5678).

In a fourth step, for example after the time of the loan is over, for example, after 20 days, when an ECS request is be triggered, the server 202 sends the debit request to the issuer 210 of the card of the second user (for example, an ECS with a debit request is raised for an amount of $180 plus interest (for example $36) from the card of the second user, for example card xxxxxxxxxxxx5678).

In a fifth step and a sixth step, then the issuer 210 of the card of the second user approves the amount (for example, with an ‘approved’ message in the fifth step), the server 202 deducts the loan amount (for example, $180) plus interest to be paid by the second user (for example, $36) from the issuer 210 of the card of the second user and deposits (in other words: credits) the loan amount (for example, $180) plus the interest earned by the first user (for example, $30) to the issuer 206 of the card of the first user against the first user's card (for example, card xxxxxxxxxxxx1234). The server 202 may keep the difference between the interest to be paid by the second user and the interest earned by the first user (for example, $6) as a processing fee.

It will be understood that although in the information flow as described in the figures, reference is made to messages or steps, which are represented by different arrows, two or more of those messages may be combined into a single message, and likewise, one or more steps may be combined into a single step. In other words, the arrows in the figures represent information flow, and although reference is made to “a message”, not every piece of information is necessarily exchanged in a single message. Furthermore, when reference is made to a step, the corresponding message is addressed, and vice versa.

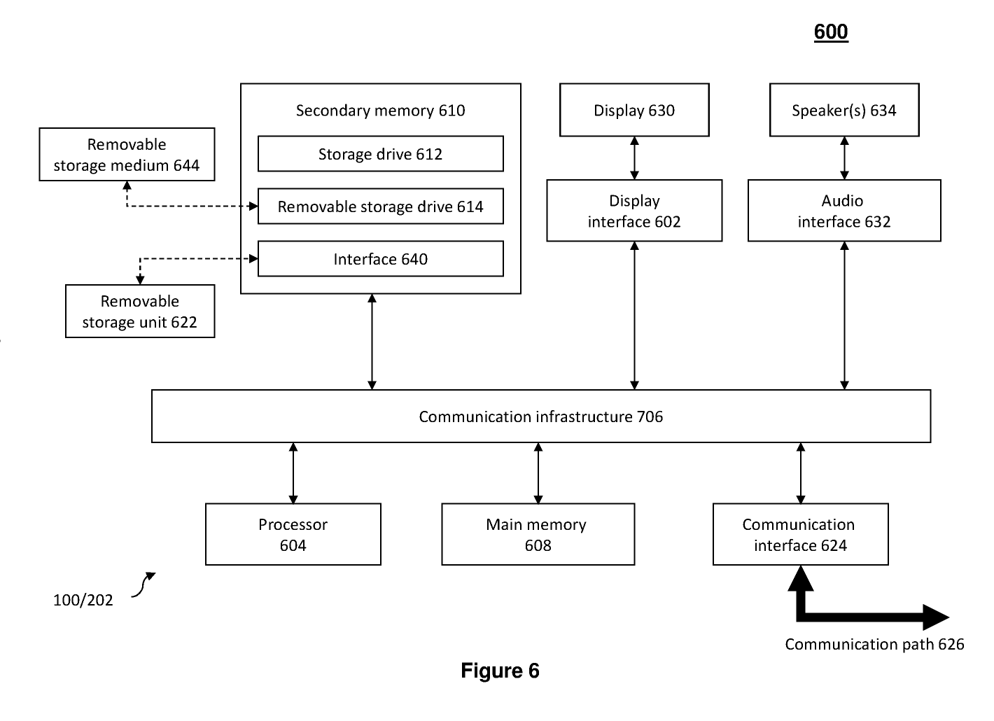

FIG. 6 depicts an exemplary computing device 600, hereinafter interchangeably referred to as a computer system 600 or as a server 600, where one or more such computing devices 600 may be used to implement the credit transfer server 110 shown in FIG. 1B and/or the credit transfer server 202 shown in FIGS. 2 to 5. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage medium 644 in a well-known manner. The removable storage medium 644 may include magnetic tape, optical disk, non-volatile memory storage medium, or the like, which is read by and written to by removable storage drive 614. As will be appreciated by persons skilled in the relevant art(s), the removable storage medium 644 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 650. Examples of a removable storage unit 622 and interface 650 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 650 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the disclosure, the communication interface 624 permits data to be transferred between the computing device 600 and a data communication network, such as a public data or private data communication network. The communication interface 624 may be used to exchange data between different computing devices 600 which such computing devices 600 form part of an interconnected computer network. Examples of a communication interface 624 can include a modem, a network interface (such as an Ethernet card), a communication port (such as a serial, parallel, printer, GPIB, IEEE 1394, RJ45, USB), an antenna with associated circuitry, and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602, which performs operations for rendering images to an associated display 630 and an audio interface 632 for performing operations for playing audio content via associated speaker(s) 634.

As used herein, the term “computer program product” (or computer readable medium, which may be a non-transitory computer readable medium) may refer, in part, to removable storage medium 644, removable storage unit 622, a hard disk installed in storage drive 612, or a carrier wave carrying software over communication path 626 (wireless link or cable) to communication interface 624. Computer readable storage media (or computer readable media) refers to any non-transitory, non-volatile tangible storage medium that provides recorded instructions and/or data to the computing device 600 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card, such as a PCMCIA card, and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 400 using the removable storage drive 414, the storage drive 412, or the interface 450. The computer program product may be a non-transitory computer readable medium. Alternatively, the computer program product may be downloaded to the computer device 400 over the communications path 426. The software, when executed by the processor 404, causes the computing device 400 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts. The main memory 608 and/or the secondary memory 610 may serve(s) as the memory for the credit transfer server 110 (or 202); while the processor 604 may serve as the processor of the credit transfer server 110 (or 202).

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices, such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on such a computer effectively results in an apparatus that implements the steps of the disclosed method.

According to various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g., a microprocessor (e.g., a Complex Instruction Set Computer (CISC) processor or a Reduced Instruction Set Computer (RISC) processor). A “circuit” may also be a processor executing software, e.g., any kind of computer program, e.g., a computer program using a virtual machine code such as, e.g., Java. Any other kind of implementation of the respective functions which will be described in more detail below may also be understood as a “circuit” in accordance with an alternative embodiment.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for transferring credit from a first card belonging to a first user to a second card belonging to a second user, the method comprising:
receiving from the first user an offer message indicating an offer including an offered amount, wherein the offer further includes other information, the other information including one or more of cost, time, or other terms and conditions;
receiving from the second user a request message indicating a request for a requested amount;
determining whether the offer and the request fulfil a pre-determined condition; and
if it is determined that the offer and the request fulfil the pre-determined condition, initiating debiting a pre-determined amount from the first card and crediting the pre-determined amount to the second card.

2. The method of claim 1, wherein the pre-determined condition comprises at least one of:
that the request is originating from a user whose credit score fulfils a pre-determined requirement;
that the requested amount is less than or equal to the offered amount;
that a requested time is less than or equal to an offered time; or
that the second user is agreeing to the other information.

3. The method of claim 1, further comprising determining a credit score of the second user.

4. The method of claim 1, wherein the pre-determined amount is less than or equal to at least one of the offered amount or the requested amount.

5. The method of claim 1, further comprising getting a hold on the offered amount in the first card.

6. The method of claim 1, further comprising:
receiving offers from a plurality of users; and
matching the request to one or more of the plurality of users.

7. The method of claim 6, wherein the requested amount is less than or equal to the sum of offered amounts of users to which the request is matched.

8. The method of claim 6, wherein the matching is based on respective costs of the offers.

9. The method claim 1, further comprising initiating debiting a first return amount based on the pre-determined amount from the second card and crediting a second return amount based on the pre-determined amount to the first card.

10. The method of claim 9, wherein the first return amount is based on the pre-determined amount and an interest to be paid by the second user.

11. The method of claim 9, wherein the second return amount is based on the pre-determined amount and an interest earned by the first user.

12. The method of claim 9, wherein the first return amount is based on the pre-determined amount and a profit of an issuer of at least one of the first card or the second card; and
wherein the second return amount is based on the pre-determined amount and the profit.

13. The method of claim 1, wherein the offered amount is an amount of the first user's credit line associated with the first card.

14. The method of claim 1, wherein the offered amount is an amount that is available to the first user from the first card free of interest.

15. A credit transfer server for transferring credit from a first card belonging to a first user to a second card belonging to a second user, the credit transfer server comprising:
a receiver configured to receive from the first user an offer message indicating an offer including an offered amount, wherein the offer further includes other information, the other information including one or more of cost, time, or other terms and conditions, the receiver further configured to receive from the second user a request message indicating a request for a requested amount;
a determination circuit configured to determine whether the offer and the request fulfil a pre-determined condition; and
a transfer initiator configured to initiate debiting a pre-determined amount from the first card and crediting the pre-determined amount to the second card if it is determined that the offer and the request fulfil the pre-determined condition.

16. The credit transfer server of claim 15, wherein the pre-determined condition comprises at least one of:
that the request is originating from a user whose credit score fulfils a pre-determined requirement;
that the requested amount is less than or equal to the offered amount;
that a requested time is less than or equal to an offered time; or
that the second user is agreeing to the other information.

17. The credit transfer server of claim 15, wherein the pre-determined amount is less than or equal to at least one of the offered amount or the requested amount.

18. The credit transfer server of claim 15, wherein the transfer initiator is further configured to get a hold on the offered amount in the first card.

19. The credit transfer server of claim 15, wherein the receiver is further configured to receive offers from a plurality of users; and
wherein the determination circuit is further configured to match the request to one or more of the plurality of users.

20. A computer readable storage medium comprising instructions for transferring credit from a first card belonging to a first user to a second card belonging to a second user, which, when executed by a processor, cause the processor to:
receive from the first user an offer message indicating an offer including an offered amount, wherein the offer further includes other information, the other information including one or more of cost, time, or other terms and conditions;
receive from the second user a request message indicating a request for a requested amount;
determine whether the offer and the request fulfil a pre-determined condition; and
if it is determined that the offer and the request fulfil the pre-determined condition, initiate debiting a pre-determined amount from the first card and crediting the pre-determined amount to the second card.
